(19) United States
(12) Patent Application Publication
(10) Pub. No.: US 2015/0218957 A1
(43) Pub. Date: Aug. 6, 2015

(54) GUIDE VANE SEAL

(71) Applicant: UNITED TECHNOLOGIES CORPORATION, Hartford, CT (US)

(72) Inventors: Carl Brian Klinetob, East Haddam, CT (US); Nicholas D. Stilin, Higganum, CT (US)

(21) Appl. No.: 14/428,749

(22) PCT Filed: Mar. 1, 2013
(86) PCT No.: PCT/US2013/028515

§ 371 Date: Mar. 17, 2015

Related U.S. Application Data
(60) Provisional application No. 61/708,306, filed on Oct. 1, 2012.

(51) Int. Cl. F01D 11/00; F01D 9/02; F02C 3/04

(52) U.S. Cl. CPC F01D 11/001; F02C 3/04; F01D 9/02

(57) ABSTRACT

A seal for use with a static guide vane of a gas turbine engine has a strap member extending to a generally cylindrical bulb. The bulb forms a diameter, and is spaced a distance defined between an end of the strap remote from the bulb, to a point on the bulb furthest from the end. A ratio of the diameter to the distance is between 0.2 and 0.5. A static guide vane and a gas turbine engine are also disclosed.

### CROSS-REFERENCE TO RELATED APPLICATION

This application claims priority to U.S. Provisional Application No. 61/708,306, which was filed Oct. 1, 2012.

### BACKGROUND

This application relates to a seal to seal a gap between adjacent platform edges of guide vanes for use in a gas turbine engine.

Gas turbine engines are known, and typically include a fan delivering air into a compressor section. The air is compressed and delivered into a combustion section where it is mixed with fuel and ignited. Products of this combustion pass downstream over turbine rotors driving them to rotate. The turbine rotors drive compressor and fan rotors. Historically, a common turbine rotor has driven a compressor rotor and the fan.

More recently, a gear reduction has been placed to drive the fan, such that the fan and compressor rotors can rotate at different speeds. This has allowed the size of the fan to increase dramatically. The fan typically delivers air into the compressor, but also delivers a portion of air as bypass flow into a bypass duct. With the increase in fan size, a bypass ratio, or the ratio of the air delivered into the bypass duct compared to the air delivered into the compressor has increased.

With the increase in bypass flow, the air delivered into the compressor becomes more valuable, and all air delivered into the compressor is desirably utilized efficiently. Thus, it becomes more important to limit leakage.

Within the compressor and fan sections, there are guide vanes positioned intermediate blade rows on the fan or compressor rotors. These guide vanes have platform edges which extend circumferentially towards an adjacent guide vane. There is often a gap between these edges.

Seals have been proposed to cover this gap, and prevent air from leaking inwardly or outwardly of the guide vanes. The seals to date have required relatively complex structure formed into the platforms, and also require complex assembly techniques.

### SUMMARY

In a featured embodiment, a seal for use with a static guide vane of a gas turbine engine has a strap member extending to a generally cylindrical bulb. The generally cylindrical bulb forms to a diameter, and is spaced a distance defined between an end of the strap remote from the bulb, to a point on the bulb furthest from the end. A ratio of the diameter to the distance is between 0.2 and 0.5.

In another embodiment according to the previous embodiment, the bulb includes a hollow opening.

In another embodiment according to any of the previous embodiments, the seal is formed of a silicone rubber.

In another featured embodiment, a static guide vane for use in a gas turbine engine has an airfoil extending between two radial platforms, with a suction side and a pressure side to both the airfoil and platforms. A seal is secured to a side of each of the platforms remote from the airfoil. The seal has a strap secured to the side of the platforms. An enlarged bulb sits outwardly of an edge of the platform.

In another embodiment according to the previous embodiment, a vane is designed for use in a compressor section of a gas turbine engine.

In another embodiment according to any of the previous embodiments, there is a seal on only one of the suction and pressure sides at each of the two platforms.

In another embodiment according to any of the previous embodiments, the bulb has a diameter, and a distance defined between an end of the strap remote from the bulb to a point on the bulb furthest spaced from the distance. A ratio of the diameter to the distance is between 0.2 and 0.5.

In another embodiment according to any of the previous embodiments, the seal is formed of a silicone rubber.

In another featured embodiment, a gas turbine engine has a fan, a compressor, a combustor, and a turbine. One of the fan, compressor and turbine is provided with a row of static guide vanes, which have an airfoil extending between two radial platforms, with a suction side and a pressure side to both the airfoil and platforms. There are circumferentially adjacent static guide vanes, with a seal secured to a side of each of the platforms remote from the airfoil on one of the circumferentially adjacent vanes. No seal is secured to the other. The seal has a strap secured to the side of the platforms. An enlarged bulb sits outwardly of an edge of the platform and in engagement with the other of the static guide vanes.

In another embodiment according to the previous embodiment, the bulb has a diameter, and a distance defined between an end of the strap remote from the bulb to a point on the bulb furthest spaced from the end. A ratio of the diameter to the distance is between 0.2 and 0.5.

In another embodiment according to any of the previous embodiments, the is in the compressor.

In another embodiment according to any of the previous embodiments, one of the circumferentially adjacent guide vanes is the same one at both of the platforms.

In another embodiment according to any of the previous embodiments, the seal is formed of a silicone rubber.

These and other features may be best understood from the following specification and drawings, the following which is a brief description.

### BRIEF DESCRIPTION OF THE DRAWINGS

FIG. 1 schematically shows a gas turbine engine.

FIG. 2 shows a detail of a guide vane.

FIG. 3A shows one side of a guide vane.

FIG. 3B shows an opposed of the guide vane.

FIG. 4 shows adjacent guide vanes and seals.

FIG. 5 shows a detail of a seal.

### DETAILED DESCRIPTION

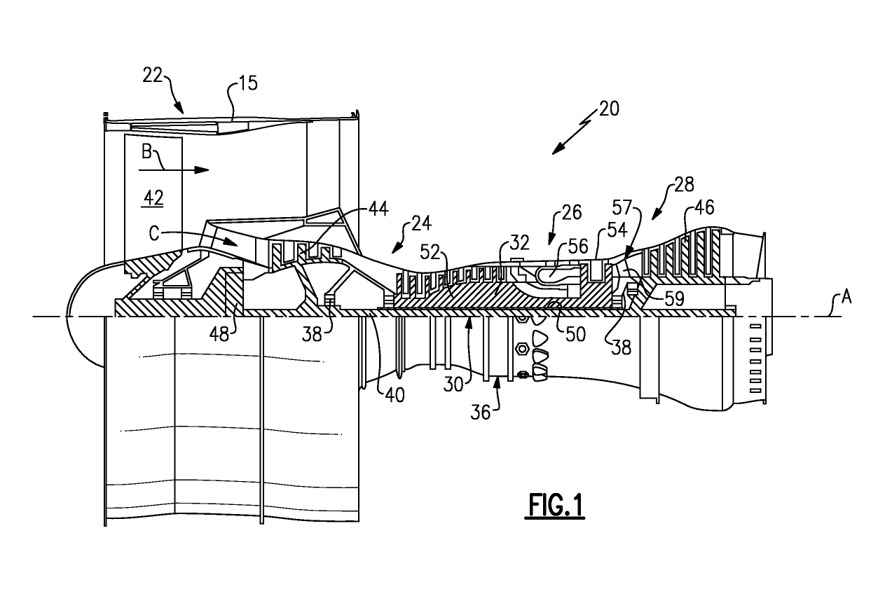

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines including three-spool architectures.

The engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that interconnects a fan 42, a low pressure compressor 44 and a low pressure turbine 46. The inner shaft 40 is connected to the fan 42 through a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path. The turbines 46, 54 rotationally drive the respective low speed spool 30 and high speed spool 32 in response to the expansion.

The engine 20 in one example is a high-bypass geared aircraft engine. In a further example, the engine 20 bypass ratio is greater than about six (6), with an example embodiment being greater than ten (10), the geared architecture 48 is an epicyclic gear train, such as a planetary gear system or other gear system, with a gear reduction ratio of greater than about 2.3 and the low pressure turbine 46 has a pressure ratio that is greater than about 5. In one disclosed embodiment, the engine 20 bypass ratio is greater than about ten (10:1), the fan diameter is significantly larger than that of the low pressure compressor 44, and the low pressure turbine 46 has a pressure ratio that is greater than about 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.5:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram° R)/(518.7° R)]^{0.5}. The “Low corrected fan tip speed” as disclosed herein according to one non-limiting embodiment is less than about 1150 ft/second.

FIG. 2 shows a guide vane 80 which is illustrated as a static compressor guide vane. It should be understood that guide vanes utilized in a fan section or even the turbine section may also benefit from teachings of this application. In guide vane 80, an airfoil 81 extends away from an inner platform 78. As shown at 88, an edge of the platform 78 curves relative to the center line A of the engine such as shown in FIG. 1.

A seal 82 has a strap portion 86 secured to an underside 79 of the platform 78.

A bulb 84 is positioned outward of the edge 88. The bulb 84 is shown to have a hole 110. The seal 82 may be an extrusion, and may be formed of any elastomer that may be appropriate for the environmental conditions that the seal 82 will see during use. Silicone rubber may be used.

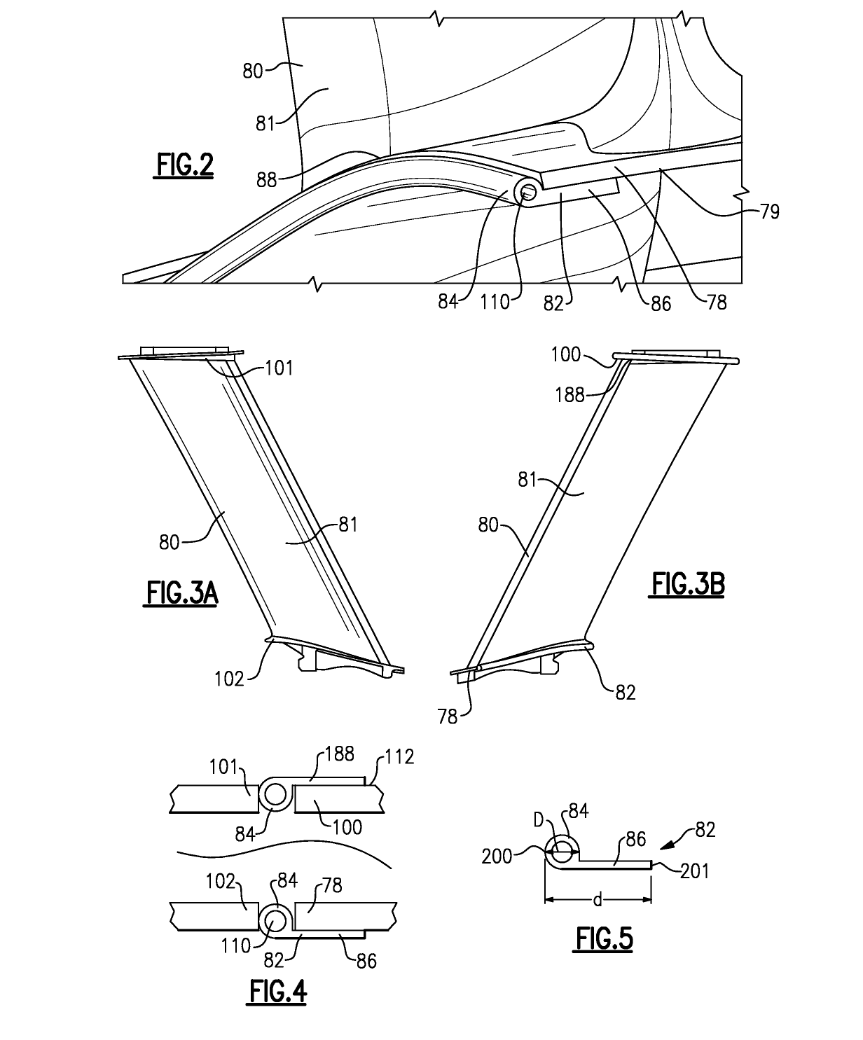

As shown in FIG. 3A, the vane 80 has a radially inner platform 102 and a radially outer platform 101 on one side. As shown in FIG. 3B, there is also the platform 78 at an inner end, and the platform 100 at a radially outer end of an opposed side. A seal 82 is placed on the FIG. 3B side of the platform 78, and a seal 188 at the radially outer platform 100. It should be understood that the platforms 100 and 101 are actually a single platform, as are the platforms 78 and 102 and each wrap around leading and trailing edges of the airfoils 81.

The combination of FIGS. 3A and 3B simply show that the seals 82 and 188 are placed on only one side of a vane 80. It should be understood that the seals at the radially inner and outer ends could be placed on opposed sides of the airfoil 81. That is, a seal could be placed on the pressure side of the airfoil 81 at, say, the radially outer location, and on the suction side of the airfoil 81 at a radially inner location. However, as shown in combination, there is typically a seal at only one side of the vane 80 at each of the radially inner and outer locations.

FIG. 4 shows the seal 82 having the bulb 84 secured to platform 78, but also abutting an edge of the platform side 102. Thus, the seal 82 provides an effective seal at the radially inner edge. Similarly, the seal 188 is shown bonded to the platform 112, and abutting the platform 101. Again, the seal 188 will provide an effective seal at the radially outer location. It would also be possible to place a seal on all four platforms of a guide vane 80, and simply not have any on adjacent vanes 80.

FIG. 5 shows a detail of the seal 82, but would this would also be true of the seal 188. A diameter D of the bulb 84 is defined, and in one embodiment was 0.125 inch (0.3175 cm). A length d from an outermost point 200 of the bulb to an innermost location 201 of the strap 86 is defined. In one embodiment, d was 0.4375 inch (1.111 cm). In embodiments, a ratio of D to d was between 0.2 and 0.5.

Although an embodiment of this invention has been disclosed, a worker of ordinary skill in this art would recognize that certain modifications would come within the scope of this invention. For that reason, the following claims should be studied to determine the true scope and content of this invention.

1. A seal for use with a static guide vane of a gas turbine engine comprising:
a strap member extending to a generally cylindrical bulb, said generally cylindrical bulb form to a diameter, and spaced a distance defined between an end of said strap remote from bulb, to a point on said bulb furthest from said end, and a ratio of said diameter to said distance being between 0.2 and 0.5.

2. The seal as set forth in claim 1, wherein said bulb includes a hollow opening.

3. The seal as set forth in claim 1, wherein said seal is formed of a silicone rubber.

4. A static guide vane for use in a gas turbine engine comprising:
an airfoil extending between two radial platforms, with a suction side and a pressure side to both said airfoil and said platforms; and
a seal secured to a side of each of said platforms remote from said airfoil, said seal having a strap secured to said side of said platforms, and an enlarged bulb sitting outwardly of an edge of said platform.

5. The vane as set forth in claim 4, wherein said vane is designed for use in a compressor section of a gas turbine engine.

6. The vane as set forth in claim 4, wherein there is a seal on only one of said suction and pressure sides at each of said two platforms.

7. The vane as set forth in claim 4, wherein said bulb having a diameter, and a distance defined between an end of said strap remote from said bulb to a point on said bulb furthest spaced from said distance, and a ratio of said diameter to said distance being between 0.2 and 0.5.

8. The vane as set forth in claim 4, wherein said seal is formed of a silicone rubber.

9. A gas turbine engine comprising:
a fan, a compressor, a combustor, and a turbine; and
one of said fan, said compressor and said turbine being provided with a row of static guide vanes, the static guide vanes having an airfoil extending between two radial platforms, with a suction side and a pressure side to both said airfoil and said platforms, and there being circumferentially adjacent static guide vanes, with a seal secured to a side of each of said platforms remote from said airfoil on one of said circumferentially adjacent vanes, and no seal secured to the other, said seal having a strap secured to said side of said platforms, and an enlarged bulb sitting outwardly of an edge of said platform and in engagement with the other of said static guide vanes.

10. The engine as set forth in claim 9, wherein said bulb having a diameter, and a distance defined between an end of said strap remote from said bulb to a point on said bulb furthest spaced from said end, and a ratio of said diameter to said distance being between 0.2 and 0.5.

11. The engine as set forth in claim 9, wherein said vane is in the compressor.

12. The engine as set forth in claim 9, wherein said one of said circumferentially adjacent guide vanes is the same one at both of said platforms.

13. The engine as set forth in claim 9, wherein said seal is formed of a silicone rubber.
